(19) United States
(12) Patent Application Publication
(10) Pub. No.: US 2024/0076566 A1
(43) Pub. Date: Mar. 7, 2024

(54) METHOD OF ADSORPTIVE DESULFURIZATION OF PYROLYZED END-OF-LIFE TIRES

(71) Applicant: Wastefront AS, Oslo (NO)

(72) Inventors: Henrik Selstam, Mölnlycke (SE); Jorge Moreno Trejo, Fornebu (NO); John William Hemmings, Fripp Island, SC (US)

(21) Appl. No.: 18/260,231

(22) PCT Filed: Dec. 21, 2021
(86) PCT No.: PCT/US2021/064583

§ 371 Date: Jun. 30, 2023

Related U.S. Application Data
(60) Provisional application No. 63/132,068, filed on Dec. 30, 2020.

(51) Int. Cl. C10L 1/04; B01D 3/14; B01D 15/20; C10B 53/07

(52) U.S. Cl. CPC C10L 1/04; B01D 3/143; B01D 15/203; C10B 53/07; C10L 2200/0469; C10L 2290/02; C10L 2290/542; C10L 2290/543

(57) ABSTRACT

This disclosure provides a method and system for desulfurizing fuel produced from pyrolysis of waste tires including adsorbing one or more polar sulfur molecules from the tire pyrolysis oil with a regenerable adsorbent, distilling the tire pyrolysis oil to separate the tire pyrolysis oil into at least two fuel products and regenerating and reusing the regenerable adsorbent material. By combining adsorption with distillation, and advantageously recycling byproducts, the methods of this disclosure allow for conversion of waste tires into fuel in a manner that is commercially viable and sustainable.

### TECHNICAL FIELD

This disclosure relates to a process for economically recovering fuel products from pyrolysis oil of waste tires. More specifically, it relates to a process for recovering desulfurized fuel products from waste tires by adsorption, distillation and regenerating the regenerable adsorbent material for reuse. Optionally, the process may include production of power from byproducts and alkyation of light aromatics in the pyrolysis oil.

### BACKGROUND

Tires are designed to withstand harsh conditions and, as a result, end-of-life tires present several challenges for disposal and recycling. The decomposition of end-of-life tires into small, predominantly hydrocarbon fragments comparable to the typical constituents of crude oil is a difficult process. Several methods to break down end-of-life tires are practiced, including microwave and conventional pyrolysis, as well as solvent-based processes.

Pyrolysis is a high temperature process in which materials are treated in the absence of oxygen and in which high molecular weight materials break down to form lower molecular weight materials. Generally, the products of pyrolysis include materials which are gaseous at ambient temperature (e.g., fuel gas), materials which are liquid at ambient temperature (e.g., pyrolysis oil) and materials which are solid at ambient temperature (e.g., char). The pyrolysis oil obtained from pyrolysis of waste tires is a complex mixture of hydrocarbons, as well as components containing sulfur, nitrogen and oxygen that can be traced back to the structures of the polymers initially present in the tires.

For example, natural rubber is used in combination with other elastomers to maintain flexibility in the tire, with styrene butadiene rubber (“SBR”) being the most common rubber component. Styrene-butadiene rubber tends to break down into low molecular weight aromatic molecules containing a single benzene ring, such as toluene, xylenes, ethylbenzene, styrene, oligomers containing several benzene rings, and light hydrocarbon gases (the remnants of the carbon chains between the benzene rings in the original SBR). Natural rubber is poly-cis-isoprene and tends to break down to oligomers of isoprene, with some rearrangement reactions leading to terpenes, such as limonene. The rubber present in tires is vulcanized, which means that there are sulfur bridges between polymer chains. During pyrolysis, the sulfur bridges are easily scissioned and form mercaptans as well as hydrogen sulfide.

In addition to the materials derived from rubber, there are a number of additional sources of organic materials in tires. These include other polymers, both polyamides and polyesters, which are present in the fabric components of some tires and which break down to polar molecules containing significant amounts of nitrogen and oxygen, such as benzoic acid and caprolactam. In addition, there are molecules derived from substances initially added as vulcanizing agents, such as 2-mercapto-benzothiazole, which can break down to benzothiazole. Tire production also generally includes adding carbon black to strengthen the rubber and a combination of steel and fibers to build the belts and reinforce the tires.

In addition to the primary pyrolysis reactions, numerous secondary reactions also take place, such as aromatization of unsaturated rings (for example, limonene to cymene) and recombination of fragments. These add to the complexity of the material and lead to a large number of distinct components being present in tire pyrolysis oil at low concentrations.

In terms of the composition, the pyrolysis oil can be considered to be largely composed of hydrocarbons (typically 80%-90%), roughly equally divided between aliphatic and aromatic materials with a lower amount (typically 10-20%) of highly polar molecules containing oxygen, nitrogen and sulfur compounds. The amounts of oxygen, nitrogen and sulfur present are typically in range 0.3-0.7%, 0.5-1.0% and 0.7-1.5%, respectively.

Due to the complex composition and breakdown processes of tires, tire pyrolysis oil differs from crude oil-derived materials used to make fuel. For example, in tire pyrolysis oil, there is very significant olefinnic unsaturation. This is inherent in the unsaturated nature of the rubber polymers. As a consequence, tire pyrolysis oils have a very high bromine number (typically over 150). In addition, due to the presence of such materials as benzothiazoles, tire pyrolysis oil contains some difficult to hydrogenate sulfur (in addition to the mercaptan sulfur that is relatively easy to remove). Accordingly, in view of the complex composition of waste tires, an alternative process to hydrogenation to desulfurize tire pyrolysis oil and produce environmentally acceptable fuel products from waste tires is needed.

### SUMMARY

Aspects of this disclosure relate to a method for desulfurizing fuel produced from pyrolysis of waste tires comprising adsorbing one or more polar sulfur molecules from the tire pyrolysis oil with a regenerable adsorbent, distilling the tire pyrolysis oil to separate the tire pyrolysis oil into at least two fuel products selected from the group consisting of kerosene, naphtha, fuel oil, fuel and diesel, regenerating the regenerable adsorbent material and reusing regenerated regenerable adsorbent material. This disclosure also relates to fuel products comprising the products thereof.

Aspects of this disclosure relate to a system for desulfurizing tire pyrolysis oil produced from pyrolysis of waste tires comprising a bank of at least two regenerable adsorbers configured in a swing cycle wherein at least one of the regenerable adsorbers adsorbs one or more polar sulfur components from the tire pyrolysis oil while another is simultaneously regenerated, a source of hot gas to regenerate the bank of at least two regenerable adsorbers, and a distillation column configured to distill the tire pyrolysis oil to obtain at least two products selected from the group consisting of kerosene, naphtha, fuel oil, fuel and diesel.

### BRIEF DESCRIPTION OF THE DRAWINGS

FIG. 1 shows a first exemplary system presented as a block flow diagram.

FIG. 2 shows a second exemplary system presented as a block flow diagram.

FIG. 3 shows a third exemplary system presented as a block flow diagram.

### DETAILED DESCRIPTION

This disclosure relates to a process including adsorption-based desulfurization and distillation of oil and gas obtained from pyrolysis of waste tires to convert impurities and produce high-quality fuel. Optionally, light aromatics in the liquids may be alkylated to improve the quality of the pyrolysis liquid and convert naphtha range aromatic molecules to kerosene range aromatic molecules. This disclosure also provides the use of high-sulfur materials extracted as power generation fuel.

The adsorption is carried out using adsorbent beds, preferably configured as a temperature swing adsorption system, with continuous production of reduced-sulfur hydrocarbon liquid. The adsorber is regenerated using temperature swing with the recovered high-sulfur fuel being available for use to generate power. The method is applicable to primary pyrolysis liquids derived directly from tires either alone or in combination with liquids derived by secondary pyrolysis of heavy liquids recovered by distillation of primary pyrolysis liquids. The process may include distillation of the reduced-sulfur pyrolysis oil into naphtha, kerosene, diesel and/or fuel oil cuts to better match market requirements. The process further optionally includes thermal cracking of the fuel oil to produce additional naphtha, kerosene and diesel range materials. The process may further include a method to regenerate the adsorbers, thereby yielding a high-sulfur material which can be used as fuel to produce power on-site.

In an exemplary practice of the methods of this disclosure, waste tires may be shredded to produce rubber chips. Rubber chips having a size of approximately 20 mm are suitable. Most of the steel wires may be removed by a magnetic separator after shredding. The remaining steel wire fragments are preferably less than 2 wt % of the total mass of the chips and may pass forward to pyrolysis.

The rubber chips may be fed to the pyrolysis system, preferably by an automatic conveyor. The pyrolysis system generally includes a parallel bank of pyrolysis reactors, a heat supply system, flue gas recycling equipment and other processes for the separation and upgrading of products. Fuel gas may be combusted with air and recycled with flue gas to provide heat for pyrolysis.

In steady operation, the fuel gas combusted to provide heat for pyrolysis may advantageously be the recycled, non-condensable fraction of the pyrolysis product, which may mainly comprises hydrogen, carbon oxides, methane and higher hydrocarbons (e.g., olefins and paraffins). Heat may be supplied to the pyrolysis reactor indirectly by hot gases from a combustion chamber. Use of hot flue gas recycle to provide heat for pyrolysis limits the metal temperature in the reactor and, consequently, reduces the amount of secondary cracking that occurs. Thus, use of hot flue gases to supply heat for pyrolysis is particularly advantageous for pyrolyzing waste tires due to the high potential of secondary cracking.

Pyrolysis generally occurs in two stages: primary pyrolysis and secondary cracking. The primary reactions typically involve thermal scissioning of chemical bonds liberating fragments of polymer chains consisting of one or several monomer groups. The primary cracking reaction may suitably be carried out at a temperature in the range of 350° C. to 800° C., more preferably 400° C. to 550° C., and slightly over atmospheric pressure. The residence time in the reactor can vary depending on the type of tires. In primary pyrolysis, the heat supplied in the reactor thermally decomposes the shredded tire chips, thereby driving off volatile materials and leaving behind carbon black and inorganic materials as solids, with some of the heavier hydrocarbons adsorbed onto the solids. The vapors or volatiles produced initially from the waste tires include a wide variety of hydrocarbons, some of which can then undergo subsequent secondary reactions.

There are several different types of secondary reactions that can occur in pyrolysis, including chain transfer reactions, addition reactions and further scissioning to produce coke and low molecular weight molecules. Some of the secondary reactions occur in the vapor phase, but many are heterogenous reactions involving molecules in the vapor phase and a solid surface. Some of the secondary reactions (such as Diels-Alder addition of olefin fragments to isoprene units to form substituted 2-hexenes—understood to be catalyzed by certain of the inorganics) form valuable products. However, other secondary reactions, such as over-cracking of condensable vapor phase hydrocarbons to gases and coke, reduce the product slate value.

The controllable variables in pyrolysis are the temperature profile through the reactor and the residence time of solids in the reactor. Another important parameter is the contact time of vapors with the solids and this is determined by the design of the reactor. In principle though, once released to the vapor phase, material leaves the reactor far more quickly than the material that stays in the solid phase.

In general, both the materials that leave the reactor in the vapor phase and the solid phase are commercially valuable. The vapor phase generally contains a condensable fraction which becomes pyrolysis oil and non-condensable fuel gas. The solid phase generally contains carbon black, residual vulcanization catalyst (e.g., zinc sulfide) and/or other inorganic materials (silica) in addition to adsorbed heavy oil (e.g., toluene extractable materials) and amorphous carbon formed from secondary reactions (e.g., coke). The solid material may become valuable recovered carbon black (rCB) after additional processing.

In view of the above considerations, it is possible to change the yields and properties of products from tire pyrolysis to some extent by varying the temperature and the residence time in the pyrolysis reactor. However, there are conflicting requirements, in that conditions which may improve the rCB may lead to a less desirable liquid product. Furthermore, conditions that improve the quality of the rCB may be in conflict with each other. For example, a higher temperature may remove the adsorbed oil, which would improve the rCB, however, the higher temperature may also lay down additional amorphous carbon, which would lower the quality of rCB.

Regardless of how the pyrolysis reactor is operated, the pyrolysis oil produced typically has a large amount of sulfur compounds, oxygenates, nitrogen compounds, olefins and aromatics. In particular, the sulfur content of tire pyrolysis oil may exceed 0.5%, which limits its value and utility as a fuel due to environmental concerns. Consequently, additional processing of tire pyrolysis oil is typically necessary to add value and render the tire pyrolysis oil into a practically usable material.

For further processing, the vapors leaving the pyrolysis reactors are cooled down so that the heavier fraction condenses to form tire pyrolysis oil and the lighter material remains in the vapor phase. The lighter material is washed using water to form a fuel gas. Optionally, the wash liquor may contain a high concentration of alkali to facilitate removal of hydrogen sulfide (with some incidental carbon dioxide) from the fuel gas. Alternatively, if water is used, H₂S may remain in the fuel gas, consequently, there will be sulfur dioxide in the flue gas, which may be removed by scrubbing.

The fuel gas produced is typically in excess of the amount required to operate the pyrolysis reactors. In typical installations, excess fuel gas is flared to dispose of it. However, the excess fuel gas may be used as a sustainable source of fuel for power production. A preferred method of power production is a generator driven by a reciprocating engine. The reciprocating engine can be the spark ignition or the compression ignition type. In either case, the excess fuel gas is aspirated into the engine together with the intake air and reduces the amount of other fuels needed.

The pyrolysis oil contains different types of hydrocarbons (e.g., aromatics, olefins and naphthenes) as well as various polar components (e.g., mercaptans, amides, acids, nitriles, benzothiazoles). The content of polar components is reduced by adsorption. Suitable adsorption bed materials need to have a high propensity to preferentially adsorb polar molecules in the presence of non-polar materials. Activated Alumina (such as BASF F-200) has appropriate properties for adsorbing polar molecules.

The full range pyrolysis liquid may be treated by running the material through an adsorption bed prior to the separation of the hydrocarbon material using distillation. Alternatively, distillation may be carried out first and one or more of the liquid products may be treated to remove polar materials by running each such material through its own adsorption bed.

In either case, the adsorption bed preferably is configured as an element of a temperature swing adsorption system which includes at least two beds of adsorbant. In operation, the pyrolysis oil is fed through the adsorption column and the impurities adsorb onto the column. The operation may continue until the components of interest break through into the product liquid. It is possible to operate the adsorber to remove most or even all types of polar materials or, alternatively, to focus on sulfur-containing materials which may have a different break through point.

After the breakthrough, the adsorption column may be considered saturated and needs to be regenerated. The regeneration sequence may involve the circulation of heated nitrogen through the adsorption column to remove the adsorbed polar materials. The polar materials removed in this process may advantageously be used as fuel for on-site processing. In one example, this may be accomplished by circulating the hot nitrogen containing the desorbed vapors directly to the air intake of an internal combustion engine generator. In an alternative example, the nitrogen may be cooled to condense the polar materials which may then be used as a liquid fuel for the internal combustion engine generator. The latter example may be used to conserve nitrogen. Additionally, in some examples, hot vitiated air from internal combustion engine exhaust may be used in place of nitrogen to regenerate the adsorption column, then the desorbed vapors can be recycled to the air intake of the internal combustion engine generator.

If the adsorption is performed before distillation, the non-polar fraction is then fed to distillation and is distilled into up to four cuts comprising naphtha, kerosene, diesel and fuel oil. Distillation may be carried out using any conventional distillation column sequence, incorporating one or more side draws in addition to overhead and bottoms products. A convenient method employs a two column system, the first column operating at or slightly above atmospheric pressure to produce fuel gas (including hydrogen sulfide and carbon oxides) naphtha and water as overhead liquid products, kerosene as an optional side draw product and a combined diesel-plus-fuel oil material as a bottoms product. The diesel-plus-fuel oil mixture may be conveniently split into separate diesel and fuel oil streams using vacuum distillation. Typically, the reboilers on the columns would be operated at temperatures below 275° C. to avoid product degradation. This is conveniently accomplished using hot oil heated by residual heat of other steps of the process.

In an optional example, the fuel oil product is thermally treated by heating it to a temperature between 350° C. and 425° C. and allowing it to react without catalyst for a period of 60 minutes to 4 hours. The reaction can conveniently take place in an external reaction vessel which may be fitted with a hot oil coil to maintain the temperature. The fuel oil range liquid may conveniently be continuously pumped from the sump of the distillation column through a heater and continuously fed to the reaction vessel at a temperature of 350° C. to 425° C. The vessel operating at a pressure close to atmospheric with the vapor phase able to pass continuously to the atmospheric distillation column. The liquid phase from the reaction vessel is continuously fed to the first distillation column also. At the subject operating conditions, free radical reactions take place, in particular, the high molecular weight components of the fuel oil crack to form a broad range of lighter components. In addition, some rearrangement reactions are expected, forming components such as limonene from dimers of isoprene. The cracked material is, in any case, a broad range of materials including naphtha through diesel range molecules in addition to unconverted and incompletely converted fuel oil. The conditions and operation are broadly comparable to those used in visbreaking operations in oil refining.

In another optional example, the naphtha range product is reacted with the fuel gas from pyrolysis with the optional addition of a simple alcohol, such as ethanol or isopropanol. The material may be reacted on an acid catalyst (such as solid phosphoric acid or β-zeolite) at appropriate conditions to allow the alkylation of benzene rings to occur. Typically, such reactions are conducted at pressures between 5 and 50 bar, temperatures between 120° C. and 300° C., short residence times, gas phase and with excess aromatic to olefins. In such reactions, olefins and/or alcohols attach to benzene rings by the alkylation reaction, an example of which being the reaction of toluene with isopropanol to form cymene and water.

In exemplary methods, aromatics may be alkylated to increase the molecular size from the naphtha range into the kerosene or diesel range. For that reason, the ratio of aromatic to olefin is less critical since there is no desire to suppress the formation of more complex materials such as di-isopropyl benzene. Alcohols may be included in alkylation to provide a better balance between the available olefins and the available aromatics if there are not sufficient olefins to alkylate all available aromatics.

The alkylation reactor product stream is cooled and condensed and the liquids may be separated from the unreacted fuel gas components in a flash drum. The liquid is redirected to the distillation column which separates the kerosene and diesel range components from the naphtha range materials. Unreacted aromatics in the naphtha boiling range will report again to the naphtha product and be recycled. Since there are some non-aromatic materials in the naphtha range material, a small amount of naphtha range material may be purged, however, the majority of naphtha range material will be converted to more valuable kerosene and diesel range materials. Furthermore, the non-reactive paraffinic components in the fuel gas will pass through the process and may be used as fuel gas. Consequently, incorporation of alkylation enables a portion of the fuel gas to be converted to liquid product and a portion of less valuable naphtha range liquid to be converted to more valuable diesel and kerosene range product.

Depending on market conditions, typically the naphtha is of relatively low value and, as noted above, fuel gas is typically produced in excess. Consequently, low-value fuel product is typically available to produce sustainable power on-site. Naphtha and fuel gas may be burned in either a gas turbine or a reciprocating engine (as noted above). A reciprocating engine is generally preferred due to considerations of scale. Naphtha is a poor fuel for engines as it has a low octane rating, therefore is a poor spark ignition engine fuel and is too volatile for a conventional diesel engine. However, adaptation of compression ignition engine using either the Homogeneous Charge or the Reactive Charge principle make utilization of naphtha possible.

Additionally, to improve value and marketability of the fuel products, the fuel products may optionally be blended with fuel products from other sources. Suitable materials for blending include crude oil-derived fuel, natural gas-derived fuel, coal-derived fuel, biomass-derived fuel and plastic-derived fuel. Preferably, the fuel products may be blended to balance chemical compositions of the individual components.

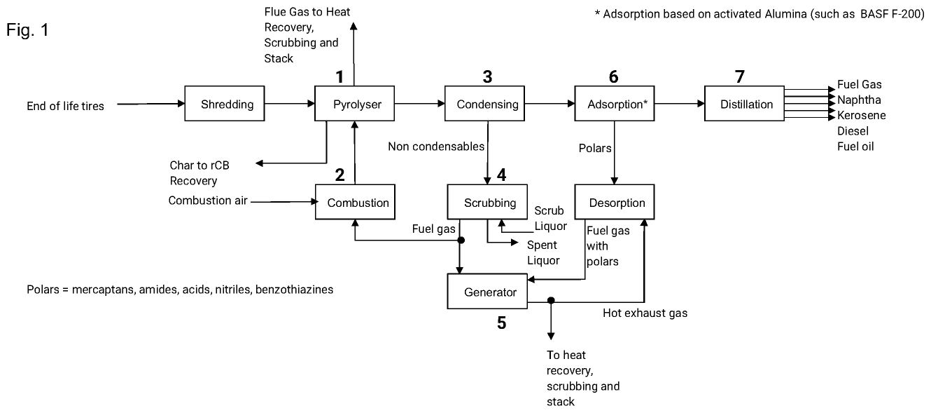

Exemplary practice of the methods of this disclosure and the products thereof will now be described with reference to FIG. 1. As shown, end-of-life tires are shredded and fed to the pyrolyzer 1. In the pyrolyzer 1, the shredded tires are heated indirectly by hot gases produced by combustion of fuel gases in the combustion zone 2. The hot combustion gases are preferably recirculated within the pyrolyzer 1 to limit the heat transfer surface temperature and prevent over-cracking of the pyrolysis products. Excess flue gas may be discharged to heat recovery (for example to produce hot oil for use as a utility or in downstream processes), scrubbed to remove sulfur and nitrogen oxides and/or treated (typically using activated carbon and a bag filter) to remove dioxins and particulates.

The raw Recycled Carbon Black (or char) from pyrolysis 1 is preferably sent to rCB upgrading, such as milling, to liberate carbon black from amorphous carbon and inorganics.

The hot vapors from pyrolysis that are not recirculated in the pyrolyzer 1 are conveyed to the condensing zone 3, where the vapors are cooled using cooling water. The heavier hydrocarbons (naphtha through Fuel Oil) condense, leaving lighter components in the gas phase (shown as non-condensables).

The non-condensables are scrubbed by aqueous liquor (e.g., dilute NaOH) in the scrubber (4), which removes hydrogen sulfide and entrained particulates. The scrubbed fuel gas may be split with the major amount being sent to the combustion zone 2 to provide heat for pyrolysis with surplus fuel gas (which may be intermittent) being sent to a generator 5. Power from the generator 5 may advantageously be used in the plant, such as in the electrolyzer 8 to provide hydrogen for to the hydroprocessor 6.

The generator 5 may be driven by a reciprocating engine or a gas turbine. In either case, the fuel gas is blended into the air intake. Reciprocating engines are a more scale-appropriate choice for a typical end-of-life tires recovery facility. The reciprocating engine generator is preferably adapted to use at least three separate fuels. One fuel is excess fuel gas as described above. A second fuel is vitiated air containing polar molecules derived from the liquid as a vapor (described more fully below). The third fuel depends on whether the engine selected is compression ignition (Diesel) or spark-ignition (Otto). In the case of a diesel cycle, the third fuel will be diesel oil. In the case of spark ignition, the third fuel may be natural gas. The amount of the third fuel is modulated by the engine governor and compensates for any fluctuations in the amounts of the other two fuels.

The liquid from the condensing zone 3 is separated into aqueous and non-aqueous components. The aqueous liquid may be combined with the spent liquor from scrubbing and sent to disposal. The non-aqueous liquid may pass to the adsorber 6. The adsorber 6 may be configured as a temperature swing adsorption system including a multiplicity of vessels filled with a solid adsorbent with a high selectivity for polar molecules, such as activated alumina (e.g. BASF F-200). In FIG. 1, an on-line vessel in adsorption mode is depicted as “Adsorption” and a second vessel in desorption/regeneration mode is depicted as “Desorption.” However, it should be understood that the vessels may alternate between modes during swing operation such that at least one is used for absorption while at least one is processed for desorption/regeneration, and, after breakthrough, the vessel used for absorption may be switched to desorption/regeneration mode while the desorbed/regenerated vessel is switched to adsorption mode.

As the liquid flows through the adsorption column, polar molecules such as organic acids, nitrogen and sulfur compounds are preferentially adsorbed onto the solid phase. The adsorption continues as the capacity of the adsorbent is used up and a “front” of composition moves through the bed until it ultimately breaks through. Since the different types of polar molecules have different affinities for the activated alumina, they will break through at different times. Since there is a wide range of materials present in the liquid, the relevant breakthrough points are when total sulfur, total nitrogen and TAN (total acid number) break through. These are aggregated parameters that are easily measured in practice. Typically, sulfur breakthrough will be of interest.

Typically, a bed will be kept in adsorption mode until sulfur breaks through and then that bed is taken offline and a different bed is brought on-line. The offline bed may be desorbed/regenerated by the following procedures. First, the bed may be drained of liquid, optionally with the liquid being sent to distillation. Second, the bed may be regenerated by passage of hot gases, optionally hot exhaust gas (vitiated air) from a generator. The hot exhaust gases increase the temperature of the adsorber bed, eventually liberating the adsorbed polar molecules. The gas stream leaving the adsorber is vitiated air containing vapors from the polar molecules. This material may be advantageously returned to the generator via the air intake and form a part of the fuel.

The desulfurized liquid from the adsorption bed, which may be low-sulfur or sulfur-free, is forwarded to the distillation column 7. In the distillation column, the material is separated into product streams and any dissolved fuel gas is liberated. Typically, this would be accomplished using two distillation columns, thus reference herein to “a distillation column” should be understood as inclusive of a system including multiple distillation columns. Fuel gas is the non-condensable stream (if any) from the first distillation column which produces naphtha as overhead, kerosene as side draw and bottoms stream with the heavier components. The bottoms stream from the first distillation column is forwarded to a second distillation column which produces diesel as an overhead product and fuel oil as a bottoms product.

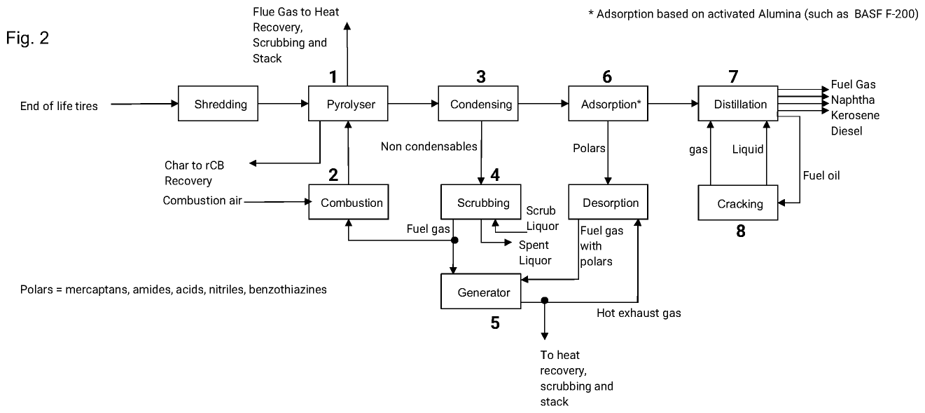

FIG. 2 shows an exemplary system with the addition of thermal processing of the fuel oil liquid. The thermal cracking system 8 receives fuel oil from the distillation column 7 and transfers the liquid using a pump through a heater (which can be either heated by hot oil or a direct fire heater) to a temperature in the range 350° C. to 425° C. The heated oil proceeds to a holding vessel, which is preferably well-insulated and provided with a means of maintaining the temperature at the desired condition 350 to 425° C. The holding vessel has both liquid and vapor spaces and acts as a separation vessel between liquid and vapor. Heated liquid continuously enters the holding vessel and both liquid and vapor continuously leave the holding vessel. The vessel is sized for liquid hold up between 1 and 4 hours. The reactions of interest occur predominantly in the liquid phase with some product released into the vapor phase. Conditions are maintained at mild temperature so that coke-forming reactions are not favored. However, it may be necessary to remove coke at intervals and the vessel can be designed accordingly. The operating pressure may be close to atmospheric. Liquid and vapor streams from thermal cracking may proceed continuously back to distillation column 7.

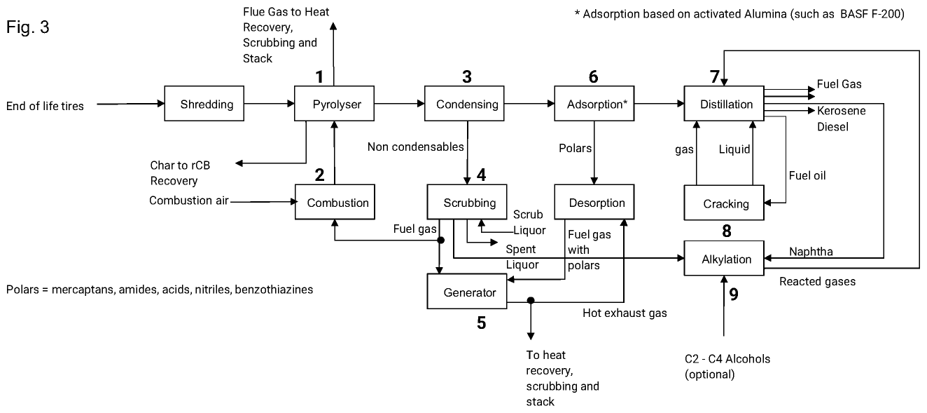

FIG. 3 shows a third exemplary system including the addition of an alkylation reactor 9. Alkylation is an addition reaction between aromatic rings and olefins which result in the olefin forming a branch attached to the aromatic center. All aromatics are active for such reactions to some extent. In typical applications in the chemical industry, the objective is to produce specific alkylates in high yield. For example, the alkylation of benzene with propylene to form cumene. That particular reaction has been practiced since the 1940's to produce high octane gasoline components. In the present context, there is no specific desire to obtain particular products. Rather, it is suitable to simply increase the molecular weight of naphtha range materials into the kerosene or diesel range. As such, it is not a disadvantage to attach more than a single olefin group to an aromatic center.

There are several aromatics present in the naphtha, mainly toluene, mixed xylenes, styrene and ethyl benzene. These are all able to react with olefins (e.g., ethylene, propylene, butenes and butadiene) to attach additional chains, for example toluene may react with propylene to form cymene. It is anticipated that the ratio of olefins to aromatics will be below 1:1 and consequently there may be advantage in supplementing with alcohol, likely ethanol or isopropanol, but in principle any low molecular weight alcohol. It should also be noted that with acid-type alkylation catalysts, dehydration of alcohols may be carried out simultaneously with the alkylation reaction and consequently alcohols may be used in place of olefins.

The reaction occurs at low residence time (0.01 to 0.1 WHSV) in the gas phase at moderately elevated pressure (5 to 20 bar) and moderately high temperature (100° C. to 300° C.) using an acid catalyst such as solid phosphoric acid and preferably a zeolite such as H-βzeolite. Suitable catalysts are commercially available.

Naphtha from distillation column 7 may be pumped to an appropriate pressure, vaporized, mixed with compressed fuel gas from pyrolysis and optionally an alcohol feedstock and heated to reaction temperature. The gaseous mixture is fed to a alkylation reactor 9 typically a packed bed of catalyst and the reactor effluent (containing unreactive paraffinic gases as well as reaction products and unreacted aromatics) is then fed to back to the distillation system 7 which separates the unreactive gases (to fuel gas) from unreacted naphtha range material (somewhat depleted in aromatics) and higher boiling range materials which include the alkylated products.

1. A method for desulfurizing fuel produced from pyrolysis of waste tires comprising:
a) providing a tire pyrolysis oil obtained from pyrolyzed waste tires;
b) adsorbing one or more polar sulfur molecules from the tire pyrolysis oil with a regenerable adsorbent;
c) distilling the tire pyrolysis oil to separate the tire pyrolysis oil into at least two fuel products selected from the group consisting of kerosene, naphtha, fuel oil, fuel and diesel;
d) regenerating the regenerable adsorbent material; and
e) reusing regenerated regenerable adsorbent material in step b).

2. The method according to claim 1, wherein:
a) the adsorbing is performed prior to the distilling, or
b) the distilling is performed prior to the adsorbing and the adsorbing is performed separately on each distillation fraction.

3. The method according to claim 1, wherein the regenerable adsorbent is a solid adsorbent selective for the polar molecules.

4. The method according to claim 1, further comprising regenerating the adsorbent by contacting the adsorbent with heated exhaust gas supplied by a generator that powers at least one apparatus performing the method of claim 1.

5. The method according to claim 1, further comprising desorbing a fuel gas from the adsorbent and utilizing the desorbed fuel gas as a source of fuel for a generator that powers at least one apparatus performing the method of claim 1.

6. The method according to claim 1, wherein providing the tire pyrolysis oil comprises pyrolyzing waste tires to obtain a vapor phase and a solid phase and condensing the vapor phase in a condenser to obtain the tire pyrolysis oil and a remaining vapor phase, and further comprising scrubbing the remaining vapor phase to form a scrubbed fuel gas.

7. The method according to claim 6, further comprising recycling the scrubbed fuel gas as a source of fuel for a generator.

8. The method according to claim 6, further comprising reacting the vapor phase with an alcohol on an acid catalyst to alkylate naphtha range product in the vapor phase.

9. The method according to claim 6, further comprising removing the solid phase for recovery of carbon black.

10. The method according to claim 1, wherein the tire pyrolysis oil has a sulfur content of less than 50 ppm after adsorption.

11. The method according to claim 1, further comprising subjecting a fuel oil fraction of the distilling step to thermal cracking and recycling a thermally cracked product stream to the distilling step.

12. The method according to claim 1, further comprising alkylating a naphtha fraction of at least one of the at least two fuel products of the distilling step to convert naphtha range aromatic molecules to kerosene range aromatic molecules.

13. The method according to claim 1, further comprising blending at least one of the at least two fuel products with at least one selected from the group consisting of a crude oil-derived fuel, natural gas-derived fuel, coal-derived fuel, biomass-derived fuel and plastic-derived fuel.

14. The method according to claim 1, further comprising blending at least one of the at least two fuel products with Fischer Tropsch diesel.

15. The method according to claim 1, wherein the distilling includes a first distillation and a second distillation.

16. The method according to claim 15, wherein the first distillation separates the tire pyrolysis oil into naphtha as overhead, kerosene as a side draw, and a first bottoms.

17. The method according to claim 16, wherein the second distillation separates the first bottoms into diesel as an overhead and fuel oil as a second bottoms.

18. The method of claim 1, wherein the regenerable adsorbent is configured in a swing cycle with a second regenerable adsorbent and the second regenerable adsorbent adsorbs one or more polar sulfur components from the tire pyrolysis oil during the regenerating of the regenerable absorbent.

19. A fuel product comprising the fuel product produced according to the method of claim 1 or a blend thereof.

20. A system for desulfurizing tire pyrolysis oil produced from pyrolysis of waste tires comprising:
a) a bank of at least two regenerable adsorbers configured in a swing cycle wherein at least one of the regenerable adsorbers adsorbs one or more polar sulfur components from the tire pyrolysis oil while another is simultaneously regenerated; and
b) a source of hot gas to regenerate the bank of at least two regenerable adsorbers; and
c) a distillation column configured to distill the tire pyrolysis oil to obtain at least two products selected from the group consisting of kerosene, naphtha, fuel oil, fuel and diesel.

21. The system according to claim 20, further comprising:
a condenser for condensing a vapor phase of pyrolysis of waste tires into the tire pyrolysis oil and a remaining vapor phase, and
a scrubber connected to the condenser configured to recover a fuel gas from the remaining vapor phase.

22. The system according to claim 21, further comprising a generator fluidly connected to the scrubber and fueled by the fuel gas supplied from the scrubber.

23. The system according to claim 21, further comprising a generator that is fueled by fuel gas supplied by regenerating at least one of the at least two regenerable adsorbers and that supplies the source of hot gas to the bank of at least two regenerable adsorbers.

24. The system according to claim 20, further comprising a thermal cracker fluidly connected to the distillation column.

25. The system according to claim 20, further comprising a reactor fluidly connected to the distillation column for alkylating the upgraded fuel.

26. The system according to claim 20, further comprising a shredder, a pyrolyzer and condenser.
